(19) United States
(12) Patent Application Publication
(10) Pub. No.: US 2023/0091061 A1
(43) Pub. Date: Mar. 23, 2023

(54) MACHINE LEARNING-BASED FLEXIBLE INTELLIGENT ADHESIVE DISPENSING SYSTEM AND METHOD

(71) Applicant: Wuhua Energy Technology Co., Ltd, Xi'an City (CN)

(72) Inventors: Shen XU, Xi'an City (CN); Xiaohong YANG, Xi'an City (CN); Gongquan LIU, Xi'an City (CN); Zheyu LI, Xi'an City (CN); Ling WEI, Xi'an City (CN); Yong XIAO, Xi'an City (CN); Yong HUO, Xi'an City (CN); Feng WEI, Xi'an City (CN); Feng WANG, Xi'an City (CN); Songqiao ZHANG, Xi'an City (CN); Pengcheng DU, Xi'an City (CN); Fangfang JIANG, Xi'an City (CN); Fan JIANG, Xi'an City (CN); Long ZHANG, Xi'an City (CN); Baiteng GUO, Xi'an City (CN); Shuai LIU, Xi'an City (CN); Zihao ZHAO, Xi'an City (CN); Yirong MAO, Xi'an City (CN)

(21) Appl. No.: 17/733,161

(22) Filed: Apr. 29, 2022

(30) Foreign Application Priority Data
Sep. 18, 2021 (CN) 202111098793.1

(51) Int. Cl. G05B 13/02; B05C 5/02; G06N 5/00

(52) U.S. Cl. CPC G05B 13/024; B05C 5/02; G06N 5/003

(57) ABSTRACT

The present disclosure is applicable to the technical field of metering and distributing of an adhesive dispensing machine, and provides a machine learning-based flexible intelligent adhesive dispensing method. Specific steps are as follows: first, establishing a reference process database; second, performing coarse scanning on a product tray by a scanning module, identifying a product model number, directly calling adhesive dispensing data fitted in a previous period by the central control system according to the product model number, and controlling the adhesive dispensing module to roughly adjust an adhesive dispensing posture; three, performing precise scanning on a body of each shaped charge in the product tray through the scanning module, performing real-time classification and fitting on the data of the product tray through the central control system, and correcting the called adhesive dispensing data through the fitted data; and fourth, executing an adhesive dispensing action by an adhesive dispensing machine table according to newest adhesive dispensing data. According to the method, the mixed-line and mixed-type continuous automatic adhesive dispensing operation of shaped charges is realized, which greatly reduces or eliminates the debugging cost, shortens the production cycle of new products, and has relatively strong industrial promotion and application value.

### CROSS REFERENCE TO RELATED APPLICATION

This patent application claims the benefit and priority of Chinese Patent Application No. 202111098793.1 filed on Sep. 18, 2021, the disclosure of which is incorporated by reference herein in its entirety as part of the present application.

### TECHNICAL FIELD

The present disclosure belongs to the technical field of metering and distributing of an adhesive dispensing machine, and particularly relates to a machine learning-based flexible intelligent adhesive dispensing system and method.

### BACKGROUND ART

An existing adhesive dispensing system is mainly applicable to the electronic industry. It is mainly used for performing an adhesive dispensing operation on a regular and flat surface such as a circuit board and a speaker. The regional consistency of the products to be subjected with adhesive dispensing is good and the batches are relatively stable. A vertical projection of an adhesive dispensing trajectory is generally a central symmetrical figure, and the adhesive dispensing trajectory is relatively regular. A predetermined trajectory does not need to be adjusted during an adhesive dispensing process.

The existing adhesive dispensing system mainly faces continuous adhesive dispensing of a single product, which cannot meet an adhesive dispensing operation of a mixed-line or mixed-type product, and there is no automatic adhesive dispensing system applied to the field of production of civil explosives or ammunitions and initiating explosive devices.

### SUMMARY

An objective of an embodiment of the present disclosure is to provide a machine learning-based flexible intelligent adhesive dispensing system and method, which aims to solve the problems that the existing adhesive dispensing system mainly faces continuous adhesive dispensing of a single product, and cannot meet an adhesive dispensing operation of a mixed-line or mixed-type product, and that there is no automatic adhesive dispensing system applied to the field of production of civil explosives or ammunitions and initiating explosive devices.

The embodiments of the present disclosure are implemented in a machine learning-based flexible intelligent adhesive dispensing system, the system includes a product tray loading module, where the product tray loading module includes product trays and shaped charges mounted in the product trays, and the system further includes:

a scanning module, where the scanning module includes a scanner, used for performing coarse scanning and secondary precise scanning on the product trays;

a central control system, where the central control system includes parameter sets obtained by qualifying various parameters of each product; and

an adhesive dispensing module, where the adhesive dispensing module includes an adhesive dispensing machine table, and the central control system drives the adhesive dispensing module to perform adhesive dispensing dynamically according to data collected by the scanning module.

A machine learning-based flexible intelligent adhesive dispensing method includes the following specific adhesive dispensing steps:

establishing and storing step, configured for establishing a reference process database, storing parameter sets obtained by quantifying various parameters of adhesive dispensing in a man-machine interface controller in a central control system, and taking each product as a parameter set;

identifying and calling step: configured for performing coarse scanning on a product tray conveyed by front-end logistics, through a scanning module; identifying a product model number, directly calling adhesive dispensing data fitted in a previous period by the central control system according to the product model number, and controlling an adhesive dispensing module to roughly adjust an adhesive dispensing posture through the central control system;

performing and correcting step, configured for performing precise scanning on a body of each shaped charge in the product tray through the scanning module, especially three-dimensional coordinate characteristic quantities at a sealing part of each shaped charge; performing real-time classification and fitting on data of the product tray through the central control system, and correcting the adhesive dispensing data called, through the data of the product tray fitted; and

executing step, configured for executing an adhesive dispensing action by an adhesive dispensing machine table according to newest adhesive dispensing data.

In a further technical solution, in the establishing and storing step, when a product parameter set is newly added, the adhesive dispensing module is debugged first so as to reach a best effect, and the product parameter set newly added, in a state of the best effect, is stored into the central control system.

In a further technical solution, in the identifying and calling step, a scanner used by the scanning module is a blue-ray three-dimensional scanner.

In a further technical solution, in the performing and correcting step, real-time classification and fitting are performed on the data of the product tray by the central control system by using a Gradient Boosting Decision Tree algorithm. A newest adhesive dispensing trajectory dynamically fitted in real time in a machine learning manner through the standard adhesive dispensing parameters optimized and fitted, is mapped to an adhesive dispensing operation.

In a further technical solution, each product tray is provided with twenty slots for placing shaped charges.

The machine learning-based flexible intelligent adhesive dispensing system and method provided by the embodiments of the present disclosure have the following beneficial effects.

1. Product coarse classification and product model identification are performed in sequence through scanning the trays and the assembling state of products and the trays by the blue-ray three-dimensional scanner, so as to automatically match and call adhesive dispensing process parameter sets according to an identification result, thereby realizing a mixed-line and mixed-type adhesive dispensing operation.

2. The scanning rate of the used blue-ray three-dimensional scanner is 160 million times/second, and the precision reaches 0.01 mm, which has met the precision 0.1 mm required by the product. Compared with a Charged Coupled Device (CCD) camera, the blue-ray scanner can eliminate the interference of light, temperature, and humidity in a workshop.

3. The adhesive dispensing process reference parameter database is established through machine learning, and the trajectory operation and optimization time of the controller are shortened. On the other hand, the GBDT algorithm is used, optimal classification is performed on the data collected by the blue-ray three-dimensional scanner, and a reference parameter set is called according to a classification result and is corrected in combination with real-time scanning data, so as to realize trajectory calling and optimization operation of automatic adhesive dispensing, which greatly reduces or eliminates the debugging cost, shortens the production cycle of a new product, solves the difficult problem of automatic continuous adhesive dispensing of a special-shaped structure, and has relatively strong industry promotion and application value.

### BRIEF DESCRIPTION OF THE DRAWINGS

FIG. 1 is a schematic structural diagram of a machine learning-based flexible intelligent adhesive dispensing system provided by an embodiment of the present disclosure;

FIG. 2 is a flowchart of a machine learning-based flexible intelligent adhesive dispensing method provided by an embodiment of the present disclosure;

FIG. 3 is an assembly diagram of a product tray and a shaped charge during coarse scanning in the machine learning-based flexible intelligent adhesive dispensing system provided by the embodiment of the present disclosure; and

FIG. 4 is a schematic diagram of characteristics of a part to be dispensed with adhesive during precise scanning in the machine learning-based flexible intelligent adhesive dispensing system provided by the embodiment of the present disclosure.

Reference signs in the drawings: 1 product tray loading module; 2 scanning module; 3 adhesive dispensing module; 4 central control system; 5 product tray; 6 shaped charge; 7 adhesive dispensing low position; 8 adhesive dispensing narrow position; 9 adhesive dispensing wide position; and 10 adhesive dispensing high position.

### DETAILED DESCRIPTION OF THE EMBODIMENTS

In order to make the purposes, technical solutions and advantages of the present disclosure clearer, the present disclosure will be further described in detail below with reference to the accompanying drawings and embodiments. It should be understood that specific embodiments described herein are merely illustrative of the present disclosure and are not intended to limit the present disclosure.

Specific implementation of the present disclosure is described in detail in combination with specific embodiments.

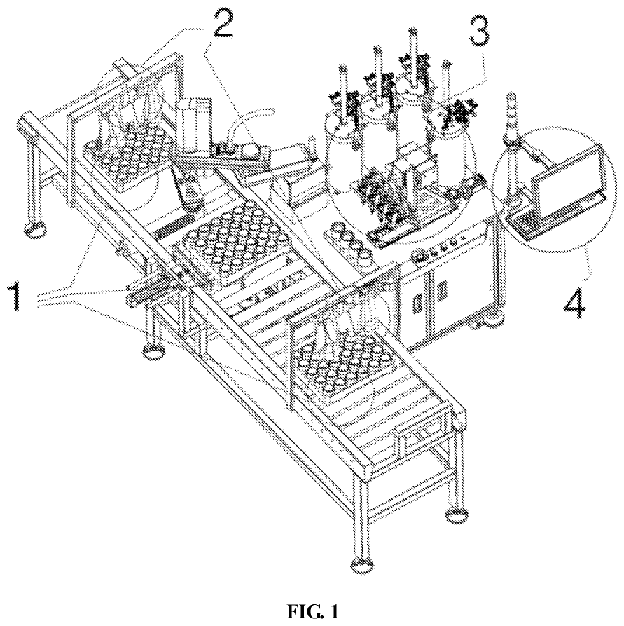

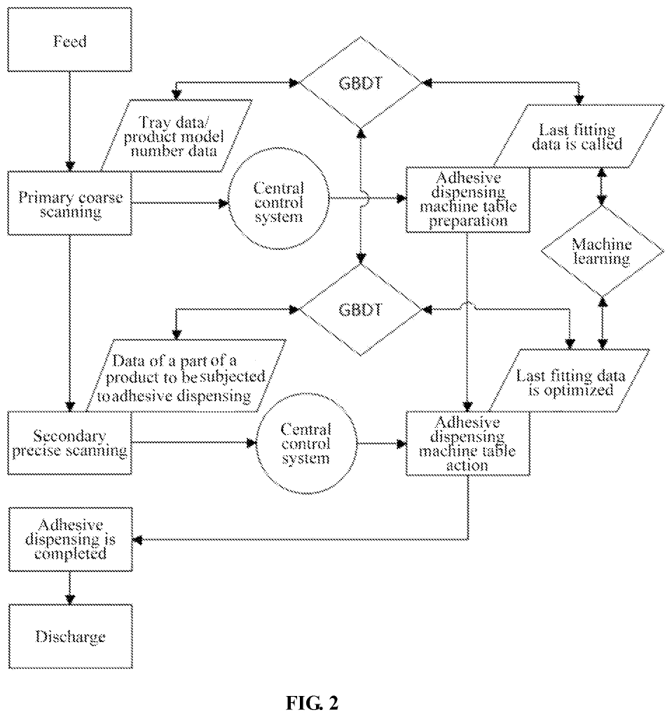

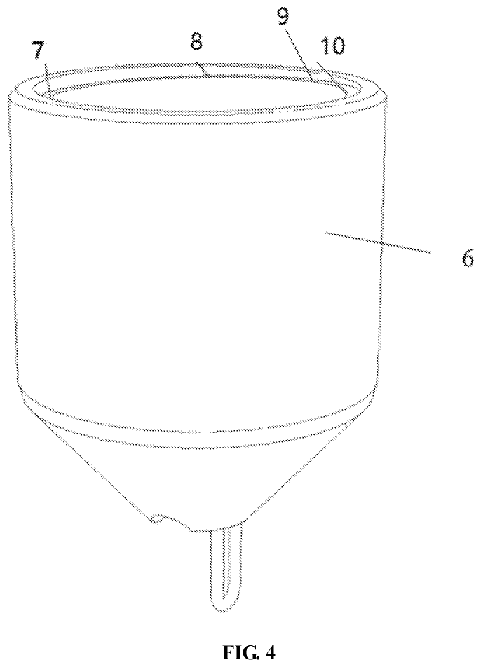

As shown in FIG. 1, FIG. 2, and FIG. 4, a machine learning-based flexible intelligent adhesive dispensing method provided by one embodiment of the present disclosure involves a product tray loading module 1, a scanning module 2, an adhesive dispensing module 3, and a central control system 4. Specific adhesive dispensing steps are as follows.

Step one, a reference process database is established. Parameter sets obtained by quantifying various parameters of adhesive dispensing are stored in a man-machine interface controller in the central control system 4. Each product is taken as a parameter set. When a product parameter set is newly added, the adhesive dispensing module is debugged first to reach a best effect, and the product parameter set newly added, in a state of the best effect, is stored into the central control system 4.

Step two, coarse scanning is performed on a product tray 5 conveyed by front-end logistics by the scanning module 2, to identify a product model number. The central control system 4 directly calls the adhesive dispensing data fitted in the previous period according to the product model, and the central control system 4 controls the adhesive dispensing module 3 to roughly adjust an adhesive dispensing posture.

Step three, precise scanning is performed on a body of each shaped charge 6 in the product tray 5 through the scanning module 2, especially the three-dimensional coordinate characteristic quantities at a sealing part of each shaped charge 6. The central control system 4 performs real-time classification and fitting on the data of the product tray 5 by a GBDT algorithm. The called adhesive dispensing data is corrected through the fitted data. A newest adhesive dispensing trajectory dynamically fitted in real time in a machine learning manner through the optimized and fitted standard adhesive dispensing parameters is mapped to an adhesive dispensing operation.

Step four, an adhesive dispensing machine table executes an adhesive dispensing action according to newest adhesive dispensing data.

In the embodiment of the present disclosure, a scanner used by the scanning module 2 is a blue-ray three-dimensional scanner. The scanning rate of the used blue-ray three-dimensional scanner is 160 million times/s, and the precision reaches 0.01 mm, which has met the precision of 0.1 mm required by the product. In addition, compared with a CCD camera used in the prior art, the blue-ray scanner can eliminate the interference of light, temperature, and humidity in a workshop. The three-dimensional coordinate characteristic quantities at the sealing part of the shaped charge 6 include an adhesive dispensing high position 10, an adhesive dispensing low position 7, an adhesive dispensing wide position 9, and an adhesive dispensing narrow position 8.

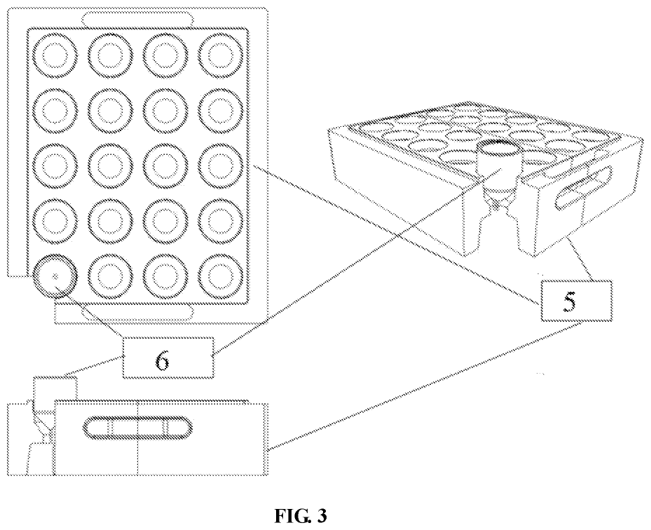

As shown in FIG. 3, as a preferred embodiment of the present disclosure, each product tray 5 is provided with twenty slots for placing shaped charges 6.The product coarse classification and the product model identification are performed in sequence through scanning the product tray 5 and the assembling state of the shaped charges 6 and the product tray 5 by the blue-ray three-dimensional scanner, so as to automatically match and call adhesive dispensing process parameter sets according to an identification result, thereby realizing a mixed-line and mixed-type adhesive dispensing operation.

The above is merely preferred embodiments of the present disclosure and is not intended to limit the present disclosure. Any modifications, equivalent replacements, improvements and the like made within the spirit and principle of the present disclosure shall fall within the scope of protection of the present disclosure.

What is claimed is:

1. A machine learning-based flexible intelligent adhesive dispensing system, comprising a product tray loading module, wherein the product tray loading module comprises product trays and shaped charges mounted in the product trays, and the system further comprises:
a scanning module, wherein the scanning module comprises a scanner, used for performing coarse scanning and secondary precise scanning on the product trays;
a central control system, wherein the central control system comprises parameter sets obtained by qualifying various parameters of each product; and
an adhesive dispensing module, wherein the adhesive dispensing module comprises an adhesive dispensing machine table, and the central control system drives the adhesive dispensing module to perform adhesive dispensing dynamically according to data collected by the scanning module.

2. The machine learning-based flexible intelligent adhesive dispensing system according to claim 1, wherein each product tray is provided with twenty slots for placing the shaped charges.

3. The machine learning-based flexible intelligent adhesive dispensing system according to claim 1, wherein the scanner used by the scanning module is a blue-ray three-dimensional scanner.

4. A machine learning-based flexible intelligent adhesive dispensing method, comprising following specific adhesive dispensing steps:
establishing and storing step, configured for establishing a reference process database, storing parameter sets obtained by quantifying various parameters of adhesive dispensing in a man-machine interface controller in a central control system, and taking each product as a parameter set;
identifying and calling step: configured for performing coarse scanning on a product tray conveyed by front-end logistics, through a scanning module; identifying a product model number, directly calling adhesive dispensing data fitted in a previous period by the central control system according to the product model number, and controlling an adhesive dispensing module to roughly adjust an adhesive dispensing posture through the central control system;
performing and correcting step, configured for performing precise scanning on a body of each shaped charge in the product tray through the scanning module, especially three-dimensional coordinate characteristic quantities at a sealing part of each shaped charge; performing real-time classification and fitting on data of the product tray through the central control system, and correcting the adhesive dispensing data called, through the data of the product tray fitted; and
executing step, configured for executing an adhesive dispensing action by an adhesive dispensing machine table according to newest adhesive dispensing data.

5. The machine learning-based flexible intelligent adhesive dispensing method according to claim 4, wherein in the establishing and storing step, when a product parameter set is newly added, the adhesive dispensing module is debugged first so as to reach a best effect, and the product parameter set newly added in a state of the best effect is stored into the central control system.

6. The machine learning-based flexible intelligent adhesive dispensing method according to claim 4, wherein in the performing and correcting step, real-time classification and fitting are performed on the data of the product tray by the central control system by using a Gradient Boosting Decision Tree algorithm.

7. The machine learning-based flexible intelligent adhesive dispensing method according to claim 4, wherein the reference process database is optimized and fitted by establishing standard adhesive dispensing parameters on a less amount of data and using the Gradient Boosting Decision Tree algorithm.

8. The machine learning-based flexible intelligent adhesive dispensing method according to claim 7, wherein a newest adhesive dispensing trajectory dynamically fitted in real time in a machine learning manner through the standard adhesive dispensing parameters optimized and fitted, is mapped to an adhesive dispensing operation.
